(19) United States
(12) Patent Application Publication
(10) Pub. No.: US 2015/0073066 A1
(43) Pub. Date: Mar. 12, 2015

(54) LOW-VISCOSITY VARNISH COMPOSITION FOR SUBSTRATE PRINTED BY INKJET

(71) Applicant: MGI FRANCE, IVRY SUR SEINE (FR)

(72) Inventors: Edmond Abergel, Paris (FR); Pierre Allais, Paris (FR)

(21) Appl. No.: 14/395,208

(22) PCT Filed: Apr. 24, 2013
(86) PCT No.: PCT/EP2013/058562

§ 371 Date: Oct. 17, 2014

(30) Foreign Application Priority Data
Apr. 24, 2012 (FR) 1253745

(51) Int. Cl. C09D 133/08; C09D 11/30

(52) U.S. Cl. CPC C09D 133/08; C09D 11/30
USPC 522/28; 522/64

(57) ABSTRACT

The present invention relates to a varnish which is for covering the surface of a printed substrate and deposited by inkjet, in which the composition of the varnish comprises at least: —at least one curable oligomer, —at least one curable monomer and —at least one photoinitiator.

The present invention relates to the field of protective layers for substrates, preferably printed substrates, and more particularly to the field of varnishes deposited by inkjet which do not require major heating at the time of deposit due to their characteristic of low viscosity.

At the time of printing, an ink is deposited on the surface of a substrate which may be in paper or plastic for example. The printed surface of this substrate is frequently coated with a protective layer. This protective layer completes the fixing of the printed image on the substrate whilst guaranteeing print resistance to some external attack such as splashed liquids, even light, heat or humidity. The depositing of this protective layer on the printed substrate is performed using an inkjet printing system for example to promote the selectivity of the deposit areas. The varnish also allows a document to be personalised by exposing areas with varnish patterns and other areas without varnish.

This application concerns low viscosity varnishes since new print-heads require the use of low viscosity products. However, reducing the viscosities of varnishes needed for print-heads using the latest technologies raises a problem for the drying or polymerisation of the varnish after printing. The less a varnish is viscous, the longer the drying or polymerisation time of the varnish and the more printing rates are decreased if the speed of transfer of the printed substrate into the ultraviolet oven is reduced to allow sufficient polymerisation. In addition, ultraviolet drying or polymerisation has the disadvantage of heating the printed substrate, which may be detrimental. Also, with the new inkjet print-heads accepting lower viscosities, if it is desired to use varnishes with high viscosity, not adapted for the viscosity needed for these new print-heads, the temperature has to be increased to reduce viscosity. In addition to detrimental energy consumption, these high temperatures influence the lifetime of the print-heads or require the use of specific materials increasing the cost of the print-heads

It is the objective of the present invention to overcome one or more disadvantages of the prior art by providing a coating ink adapted to limit risks of deterioration of print-heads, which can be used over temperature ranges not requiring strong heating of the varnish when it is deposited on the printed substrate and/or adapted for print-heads necessitating low viscosity products and/or adapted to rapid drying and/or polymerisation thereby allowing fast printing rates to be maintained and/or not requiring heating of the substrates.

This objective is reached with a varnish to coat the surface of a substrate and deposited by inkjet, the varnish composition at least comprising:
a hardenable oligomer,
a hardenable monomer, at least one hardenable monomer contained in the composition being selected from a group formed by alkoxylated and/or poly-alkoxylated acrylic monomers having one or more di- or tri-acrylates, and
a photoinitiator,
   characterized in that at least one photoinitiator is a bis-(2,4,6-trimethylbenzoyl)-phenylphosphine oxide, and in that at least one hardenable oligomer has a viscosity higher than 0.1 Pa·s at 23° C. and lower than 1 Pa·s at 23° C., and in that the weight ratio between hardenable oligomer and hardenable monomer is between 1:25 and 1:6, and in that the varnish has a viscosity of between 5 mPa·s and 40 mPa·s at 25° C., preferably lower than 22 mPa·s at 25° C., for example lower than 15 mPa·s at 25° C., and a surface tension of between 19 mN/m and 35 mN/m at 25° C.

In some embodiments, the varnish to coat the surface of a substrate e.g. a printed substrate, and deposited by inkjet is characterized in that the weight ratio between hardenable oligomer and hardenable monomer is between 1:21 and 1:7.

A further objective of the invention is to propose a process for producing a particular varnish of the present invention.

This objective is reached by means of a process for producing a varnish of the present invention which successively comprises:
a step to mix a viscosity-reducing hardenable monomer with a free radical inhibitor and a photoinitiator at a temperature of between 150 and 300° C.;
a step to cool the mixture, preferably down to ambient temperature; and
a step to add to the cooled mixture and under agitation at least one hardenable oligomer depending on the composition of the varnish, and at least one additional hardenable monomer depending on the composition of the varnish, and any other element included in the varnish composition.

According to one particular embodiment, the process for producing a varnish of the present invention is also characterized in that the process comprises:
a step to filter the mixture obtained to a particle size adapted so that it can pass through a nozzle when deposited by inkjet on the printed substrate.

The present invention also concerns the use of the varnish of the present invention as varnish for inkjet printing technology comprising a step to dry and/or polymerise the said varnish, characterized in that the temperature to which the varnish is subjected when passing through the print-heads is between 25 and 35° C., and in that the drying and/or polymerisation of the said varnish is conducted at substrate travel rates ranging from 0.05 to 10 m/s, preferably 0.5 to 10 m/s, for example 2 to 10 m/s.

In some embodiments of the present invention, the drying and/or polymerisation step of said varnish comprises exposure of the varnish to ultraviolet radiation, for example UV radiation using a conventional UV lamp, or UV radiation via light-emitting diode (LED), preferably UV radiation via a combination of light-emitting diode (LED) and conventional UV lamp.

The present invention—when the composition of the said varnish includes at least one pigment and/or colouring agent such as defined below—also concerns the direct use of the varnish of the invention as ink. This novel use is of particular industrial interest since via the inkjet printing of a single composition according to the present invention it is possible to combine the properties of ink and varnish and thereby advantageously meet the needs of the targeted use.

The invention with its characteristics and advantages will become more clearly apparent on reading the description given with reference to the appended drawing in which:

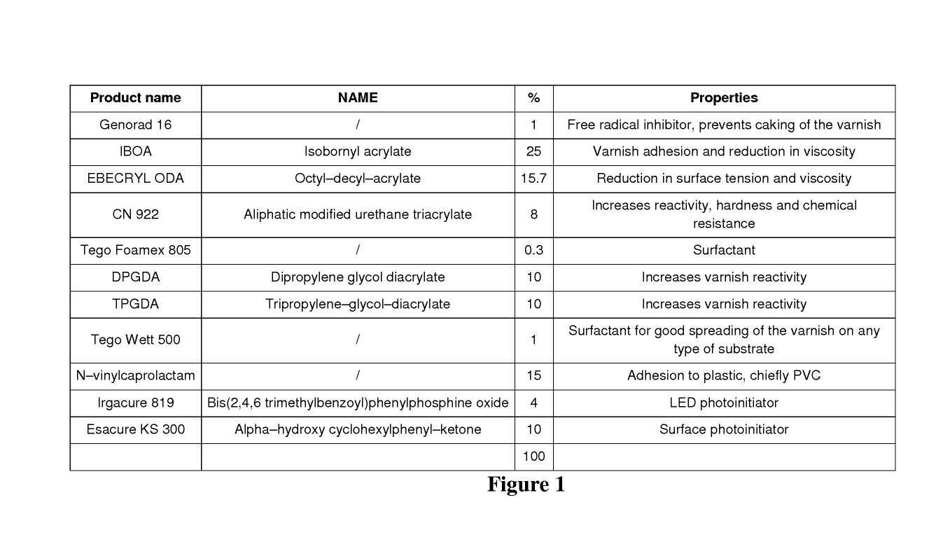

FIG. 1 shows a Table giving the composition of the varnish of the invention.

It is to be pointed out that the molecules cited in the present document are not limiting with respect to the composition of the varnish of the invention, but illustrate molecules, monomers or polymers which have or exhibit identical or similar characteristics, properties or functions.

The present invention relates to a protective varnish intended to coat the surface of a substrate, the said substrate possibly being blank or previously printed but not limited thereto. This varnish is produced without a solvent; this varnish is therefore preferably free of water and organic solvent such as methyl isobutyl ketone, methyl ethyl ketone, dimethyl ketone, isopropyl alcohol, isobutyl alcohol, n-butyl alcohol, ethyl acetate, n-butyl acetate, ethyl cellosolve, butyl cellosolve for example and other similar solvents.

The said varnish therefore includes in its composition at least one hardenable oligomer, one hardenable monomer and a photoinitiator.

According to the present invention, at least one of the hardenable monomers is an alkoxylated and/or poly-alkoxylated acrylic monomer having one or more di- or tri-acrylates.

In some preferred embodiments of the invention, at least one hardenable oligomer is selected from among those oligomers having a viscosity higher than 0.1 Pa·s at 23° C. and lower than 1 Pa·s at 23° C.; preferably these particular hardenable oligomers represent at least 75% of the total oligomer weight, preferably at least 95% of the total weight of hardenable oligomers or even the whole of the hardenable oligomers in the varnish composition of the present invention.

It is important that the choice of oligomer or the mixture of oligomers should be made from a group in which at least one component has a viscosity higher than 0.1 Pa·s at 23° C. The objective of the mixture of oligomers is to increase the reactivity of the varnish composition and the chemical and physical resistance thereof e.g. to scratching. This oligomer is associated in the varnish composition with different monomers which take part in other properties of the varnish. Depending on the type of oligomer used and the desired level of viscosity for the varnish, the ratio between oligomer and monomer in the composition has a value of between 1:25 and 1:6. According to one preferred embodiment of the varnish composition, the value of this ratio preferably lies between 1:21 and 1:7.

Depending on the type of desired varnish, i.e. depending on the type of desired physical characteristics in relation to the substrate to be coated, the choice of oligomer will differ. In the case of a polymerisation in which a rapid drying is needed to obtain a varnish having hardness or rigidity adapted for deposit on a substrate formed of a substantially rigid plastic surface, the chosen oligomer will be a urethane acrylate e.g. an aromatic urethane acrylate for example a hexa-functional aromatic urethane acrylate. This oligomer may advantageously be a modified urethane triacrylate commonly available under the reference CN 922 and having a viscosity in the order of 0.35 Pa·s at 25° C. This oligomer contributes towards reducing the viscosity of the varnish.

Other oligomers can be used in different proportions. These oligomers for example may be a hexa-functional aromatic urethane acrylate available under the trade name EBECRYL 220 and having a viscosity in the order of 28.5 Pa·s at 25° C., or for example a Bisphenol-A epoxy diacrylate available under the trade name EBECRYL 605 having a viscosity in the order of 7.5 Pa·s at 25° C. to obtain a more flexible varnish than a varnish obtained with the preceding oligomer, or for example an aliphatic urethane diacrylate available under the trade name EBECRYL 8402 and having a viscosity in the order of 12.5 Pa·s at 25° C. to obtain a varnish more flexible than a varnish obtained with the two preceding oligomers. As non-limiting examples of hardenable oligomers, mention is also made of epoxy resins such as CN 104, CN 109, EBECRYL 648, EBECRYL 3105 or a mixture of two or more of the aforementioned epoxy oligomers.

In some embodiments of the present invention, mixtures of hardenable oligomers can be envisaged, and in particular mixtures grouping together the different hardenable oligomers mentioned above (or below) so that the composition of the mixture allows a varnish to be obtained having common and even intermediate properties.

In some embodiments of the present invention, the hardenable oligomers represent 7 to 25 weight % of the varnish, preferably in the order of 8 weight % of the varnish. These proportions remain the same even if a mixture of two (or more) oligomers is used.

In some preferred embodiments of the present invention, the hardenable oligomers are not hyperbranched oligomers (also called dendrimers). Amongst the additional hardenable oligomers which could be included in the varnish composition of the present invention, the examples can be cited of urethane and/or polyester compounds which do not come under the definition of the essential particular oligomers of the present invention; if such are used these additional hardenable oligomers are to be taken into account in the weight calculations of all hardenable oligomers.

The hardenable monomers which complete the varnish composition, in addition to exhibiting hardening capability, are selected in relation to their properties.

According to the present invention at least one of the hardenable monomers is an alkoxlyated and/or poly-alkoxylated acrylic monomer having one or more di- or tri-acrylates. This type of monomers allows an increase in the reactivity of the varnish; it is called a <<reactivity function monomer>> of the varnish in the present description and the following claims. As examples of these di- or tri-acrylate hardenable monomers mention is made of tripropylene-glycol-diacrylate and/or dipropylene-glycol-diacrylate respectively known under the trade names TPGDA and DPGDA, or preferably a mixture of these two monomers. The reactivity function monomers may represent the whole of the hardenable monomers in the varnish of the present invention. However, and this forms a preferred variant of embodiment of the invention, the reactivity function monomers represent 8 to 30 weight % of the varnish, 10 to 25 weight % of the varnish, for example in the order of 20 weight % of the varnish. As examples of diacrylate monomers the following can also be cited: hexanediol di-acrylate (HDDA), dipropyleneglycol diacrylate, tripropylene glycol diacrylate, polyethylene glycol diacrylate, propoxylated neopentylglycol diacrylate, esterdiol diacrylate (EDDA) and/or triethylene glycol diacrylate (TIEGDA). As examples of tri-acrylate monomers the following can also be cited: trimethylol propane tri-acrylate, propoxylated glycerol tri-acrylate, propoxylated (3) trimethylolpropane triacrylate (TMP3POTA) and/or ethoxylated (6) trimethylolpropane triacrylate (TMP6EOTA).

Amongst the other hardenable monomers which may complete the composition of the varnish, there are function monomer(s) ensuring adhesion to the substrate called “adhesion function monomer” of the varnish in the present description and following claims. As preferred example mention is made of N-vinylcaprolactam which allows a considerable improvement in adhesion of the varnish to substantially rigid surfaces such as plastics or PVCs (polyvinyl chlorides). The adhesion function monomer may represent 10 to 25 weight % of the varnish, preferably 8 to 15 weight % e.g. in the order of 15 weight % of the varnish.

Therefore in some preferred embodiments of the present invention, the varnish, in addition to the hardenable oligomer and photoinitiator, comprises at least two hardenable monomers, the first being selected from among reactivity function monomers and the second being selected from among adhesion function monomers.

Among the other hardenable monomers possibly completing the composition of the varnish, there are function monomer(s) which allow a reduction in the viscosity of the varnish called <<viscosity function monomer>>of the varnish in the present description and following claims. As examples, aliphatic alkyl acrylates are cited having more than five carbon atoms; for example octyl-decyl-acrylate (which also has the property of restricting surface tensions in the varnish) known under the name EBECRYL ODA. The viscosity function monomer may represent 5 to 25 weight % of the varnish, preferably 12 to 18 weight % of the varnish, for example in the order of 15.7 weight % of the varnish. As examples of viscosity function monomers the following are also cited: 2(2ethoxyethoxy)ethyl acrylate (EOEOEA), Tetrahydrofurfuryl acrylate (THFA), octyl-acrylate, isodecyl acrylate (IDA), 3,3,5 trimethyl cyclohexyl acrylate (TMCHA), iso octyl acrylate (IOA), Tridecyl acrylate (TDA), 2-(2-ethoxyethoxyl)ethyl acrylate and 3,3,5 trimethyl cyclohexanol acrylate (known under the name SR 420) and/or Cyclic Trimethylopropane Formal Acrylate (CTFA).

Therefore, in some preferred embodiments of the present invention, the varnish, in addition to the hardenable oligomer and photoinitiator, comprises at least three hardenable monomers, the first being selected from among reactivity function monomers, the second being selected from among adhesion function monomers and the third being selected from among viscosity function monomers.

Among the other hardenable monomers possibly completing the composition of the varnish, there are polyvalent function monomer(s) that are called <<polyvalent function monomer>> of the varnish in the present description and following claims, since it may have several simultaneous functions such as an effect on viscosity and/or adhesion and/or other supplementary properties. As example, mention is made of the family of hardenable monomers of cycloalkyl acrylate type, in particular isobornyl acrylate (IBOA). These additional hardenable monomers may represent 20 to 30 weight % of the varnish, for example in the order of 25 weight % of the varnish.

When the varnish is jetted onto the surface of the substrate, the polymerisation reaction is initiated by at least one photoinitiator which may be a deep or surface photoinitiator. For example these photoinitiators are Irgacure 819 corresponding to bis-(2,4,6-trimethylbenzoyl)-phenyl phosphine oxide, Esacure KS 300 corresponding to alpha-hydroxy-cyclohexyl-phenyl-ketone, Esacure One corresponding to a difunctional α-hydroxy ketone (with an absorption peak at 260 nm), or preferably a mixture of at least two of the aforementioned photoinitiators e.g. a mixture of Irgacure 819 and Esacure KS 300, or preferably a mixture of Irgacure 819 and Esacure One. These photoinitiators allow the triggering of the varnish polymerisation reaction. The absorption peaks used to ensure the formation of free radicals which initiate polymerisation of the varnish generally have a wavelength in the order of 365 nm to 420 nm for Irgacure 819 and a wavelength in the order of 254 nm to 320 nm for Esacure KS 300. Esacure KS 300 is a surface photoinitiator triggering a polymerisation reaction of the varnish solely in the presence of ultraviolet radiation. This radiation can be provided for example by a device arranged in the printing system which uses the varnish. Irgacure 819 is a deep photoinitiator triggering a polymerisation reaction of the varnish in the presence of the radiation of at least one light-emitting diode (LED). This radiation can be provided for example by a device comprising at least one LED arranged in the printing system using the varnish. For example but not limited thereto the LED or LEDs used have irradiance in the order of 2 W/cm² to 10 W/cm², preferably 8 W/cm² with a wavelength in the order of 365 nm to 420 nm, preferably 405 nm. Therefore the UV drying means and the LED device allow highly efficient drying and polymerisation of a varnish having low viscosity without however reducing printing rates. Other photoinitiators could be used, for example but not limited thereto phenyl-(2,4,6-trimethylbenzoyl)-ethyl phosphinate, 2,4,6-trimethylbenzophenone, 4-methylbenzophenone, Benzyldimethylketal, 2-hydroxy-2-methyl-1-phenyl-1-propanone and/or ethyl-4-dimethylamino benzoate.

The photoinitiators may represent less than 20 weight % of the varnish, preferably 8 to 15 weight % of the varnish, for example in the order of 14 weight % of the varnish. In some preferred embodiments of the present invention, the varnish comprises Esacure KS 300 and Irgacure 819, with respectively Esacure KS 300 representing 4.0 to 10.0 weight % of the varnish e.g. in the order of 10 weight % of the varnish, and Irgacure 819 representing 2.0 to 4.9 weight % of the varnish e.g. 4 weight % of the varnish. According to another preferred variant of embodiment of the present invention, the varnish comprises Esacure One and Irgacure 819 with respectively Esacure One representing 3.0 to 10.0 weight % of the varnish e.g. in the order of 4 weight % of the varnish, and Irgacure 819 representing 2.0 to 4.9 weight % of the varnish, for example 4 weight % of the varnish.

To obtain optimal spreading of the varnish on the surface of the substrate, the composition of the varnish of the present invention may advantageously integrate a surfactant which, for example, may be the mixture listed under the name Tego Wett 500. Non-limiting examples of the surfactants which may be used include polyether siloxane, alkoxylated alcohol, a fluoro-surfactant or “silicone-free” surfactant. The surfactant may represent less than 3 weight % of the varnish, preferably 0.1 to 2.0 weight % of the varnish, for example in the order of 1.0 weight % of the varnish.

To prevent caking of the varnish under the action of heat under undesired conditions, the varnish of the present invention may integrate an antioxidant which acts as free radical inhibitor. This inhibition can be obtained for example by integrating in the composition a mixture referenced under the name Genorad 16 or Additol S110. The antioxidant may represent less than 3 weight % of the varnish, preferably 0.1 to 2.0 weight %, for example in the order of 1.0 weight % of the varnish.

Therefore in some embodiments of the present invention, the varnish (to coat the surface of a substrate and deposited by inkjet) has a composition at least comprising:
a hardenable oligomer,
a hardenable monomer,
a photoinitiator,
a surfactant, and
an antioxidant.

These five components preferably represent at least 70 weight % of the varnish, preferably at least 85 weight %, for example at least 95 weight % of the varnish or even the whole of the varnish of the present invention.

The different components which allow the producing of the varnish of the invention may also be mixed in determined proportions. Therefore, as a non-limiting example, the proportions may be:
inhibitor Genorad 16: contained in a proportion of 0.1% to 2.0%, preferably in a proportion of 1.0% of the final mixture;
surfactant Tego Wett 500: contained in a proportion of 0.1% to 2.0%, preferably in a proportion of 1.0% of the final mixture;
surface photoinitiators: contained in a proportion of 8% to 15%, preferably in a proportion of 14% with respectively Esacure KS 300 in a proportion of 4.0% to 10.0%, preferably 10%, and Irgacure 819 in a proportion of 2.0% to 4.9% preferably 4% of the final mixture;
function monomer ensuring adhesion to the substrate i.e. N-vinylcaprolactam contained in a proportion of 8% to 15% preferably in a proportion of 15% of the final mixture;
function monomer improving reactivity of the mixture i.e. tripropylene-glycol-diacrylate or TPGDA: contained in a proportion of 10% to 25%, preferably in a proportion of 10% of the final mixture;
function monomer allowing a reduction in surface tension and viscosity i.e. EBECRYL ODA, contained in a proportion of 12% to 18%, preferably in a proportion of 15.7% of the final mixture;
polyvalent function monomer i.e. isobornyl acrylate (IBOA) contained in a proportion of 20 to 30%, preferably in a proportion of 25% of the final mixture; and
hardenable oligomer i.e. modified urethane triacrylate (CN 922) contained in a proportion of 7 to 25%, preferably in a proportion of 8% of the final mixture. These proportions remain the same if a mixture of these two oligomers is used.

The whole formed by the oligomer or mixture of oligomers, the reaction activating function monomer i.e. dipropylene-glycol-diacrylate or DPGDA and the polyvalent function monomer i.e. IBOA, forms a mixture which represents 25% to 35% of the final composition, preferably 35%. The proportions are between 5% and 15% preferably 10% for DPGDA and between 20% and 30% preferably 25% for IBOA.

Depending on the type of varnish it is desired to produce, additional elements can be added to the components.

For example, for the design of a matt or satin varnish matting agents can be added to the mixture.

To obtain a glitter varnish, glitter can be added.

In some embodiments of the present invention the varnish to coat the surface of a substrate and deposited by inkjet is characterized in that the composition of the varnish comprises at least one colouring agent. This allows a particular colour to be imparted to the ink.

The colouring agent can be selected from among dyes, pigments or a combination of pigments and/or dyes. In some embodiments of the present invention, the colouring agent represents 0.1 to 35 weight % of the varnish, preferably in the order of 1 to 10 weight % of the varnish. The higher concentration of colouring agent generally relates to white colouring agents.

The coatings of transparent varnish have a preferred colouring agent concentration of 0%.

Examples of suitable pigments comprise but not limited thereto, are those known as Pigment Blue (e.g. Pigment Blue 1, 15, 15:1, 15:2, 15:3; 15:4, 15:6, 16, 24 or 60), Pigment Brown (e.g. Pigment Brown 5, 23 or 25), Pigment Yellow (e.g. Pigment Yellow 3, 14, 16, 17, 24, 65, 73, 74, 83, 95, 97, 108, 109, 110, 113, 120, 128, 129, 138, 139, 150, 154, 156 or 175), Pigment Green (e.g. Pigment Green 1, 7, 10 or 36), Pigment Orange (e.g. Pigment Orange 5, 15, 16, 31, 34, 36, 43, 48, 51, 60, 61 or 71), Pigment Red (e.g. Pigment Red 4, 5, 7, 9, 22, 23, 48, 48:2, 49, 112, 122, 123, 149, 166, 168, 170, 177, 179, 190, 202, 206, 207 or 224), Pigment Violet (e.g. Pigment Violet 19, 23, 32, 37 or 42), Pigment Black (e.g. Pigment Black 6 or 7), the numberings of the colour pigments corresponding to the “Colour Index, Volumes 1-8, published by the Society of Dyers and Colourists, Yorkshire England”; mention is also made of Black PB 2 and 5; carbon black; titanium dioxide (including rutile and anatase); zinc sulphate; or a mixture of two or more of the aforementioned pigments.

When a pigment is used in the ink compositions of the present invention it is preferred to proceed by pre-dispersing the said pigment in one or more hardenable monomers and/or hardenable oligomers, before incorporating the latter in the varnish. It is also preferred to use dispersing agents to improve the stability of the pigment dispersion; these dispersing agents allow any phenomenon of deposit and/or agglomeration of the pigments to be reduced and even prevented.

Therefore the present invention—when the composition of the said varnish comprises at least one pigment and/or a dye such as defined below—also concerns the use of the varnish of the present invention directly as an ink. This novel use is of particular industrial interest since via inkjet printing of a single composition according to the invention it becomes possible to combine the properties of ink and varnish and thereby advantageously meet the requirements of the targeted use.

The varnish may integrate at least one resin in its composition—differing from the resins of hardenable oligomer type already cited above—selected from among acrylic, vinyl, ketonic, polyester and aldehyde resins. This resin can be added to the composition in a proportion of the order of 5 to 10 weight % of the final mixture. The choice of resin depends on the substrate and the sought after result. For example, these resins have properties of improving the chemical resistance of the final composition and the mechanical resistance of the deposited varnish. One example of a vinyl resin able to provide properties of adhesion to the substrate may be the resin known under the reference VYHH.

The mixture of varnish components has a viscosity in the order of 5 mPa·s to 40 mPa·s, preferably 10 mPa·s to 15 mPa·s, preferably 12 mPa·s.

The production of the varnish of the invention is implemented by successively performing:
a step to mix the viscosity reducer with the free radical inhibitor and a photoinitiator at a temperature of between 150 and 300° C. depending on the desired mixing speed;
a step to cool the mixture down to ambient temperature;
a step to add under agitation at least one hardenable oligomer depending on the composition of the varnish and/or at least one hardenable monomer depending on the composition of the varnish, and any other element included in the varnish composition.

According to one preferred operating mode, the surfactant is added last to prevent the formation of foam during agitation of the components being mixed. To limit the onset of foam, anti-foam agents can be added to the mixture such as polyether siloxane. This anti-foam agent is added in a proportion of 0.1% to 1.0% by weight of the varnish, preferably 1 weight %. One example of a surfactant able to be used is Tego Foamex 805.

Therefore in some embodiments of the present invention, the varnish (to coat the surface of a substrate and deposited by inkjet) has a composition at least comprising:
a hardenable oligomer,
a hardenable monomer,
a photoinitiator,
a surfactant,
an antioxidant, and
an anti-foam agent.

These six components preferably represent at least 70 weight % of the varnish, preferably at least 85 weight %, for example at least 95 weight % or even the whole of the varnish of the present invention.

The production process may also comprise a step to filter the mixture obtained to a particle size adapted to pass through a nozzle when being inkjetted onto the printed substrate. Ink-jetting can be performed using any known inkjet technique, preferably the Drop on Demand technique, DOD, whereby an overpressure is formed using a piezoelectric component which curves under the effect of an electric voltage to reduce the volume of the ink reservoir. Since the varnish is sprayed via a nozzle, it is essential that the particle size of the varnish components should not lead to clogging of the nozzle. Filtering is therefore performed to a particle size of 10 μm, preferably down to 5 μm and optimally down to 1 μm.

In some embodiments, the varnish to coat the surface of a printed substrate and deposited by inkjet is characterized in that the varnish composition at least comprises:
a viscosity reducer which facilitates adhesion of the varnish to the printed substrate, and/or
a free radical inhibitor.

According to another variant of embodiment, the varnish to coat the surface of a printed substrate and deposited by inkjet is characterized in that the conductivity of the mixture of varnish components is lower than 1.5 μS.

According to one first particular embodiment, the varnish to coat the surface of a printed substrate and deposited by inkjet is characterized in that the photoinitiator further comprises alpha-hydroxy-cyclohexylphenyl-ketone.

In some embodiments, the varnish to coat the surface of a printed substrate and deposited by inkjet is characterized in that the varnish comprises N-vinylcaprolactam to ensure adhesion of the varnish to the surface of the printed substrate.

According to one particular embodiment, the varnish to coat the surface of a printed substrate and deposited by inkjet is characterized in that the hardenable oligomer having viscosity higher than 0.1 Pa·s at 23° C. comprises at least one aliphatic urethane di- and/or tri-acrylate.

According to another particular embodiment, the varnish to coat the surface of a printed substrate and deposited by inkjet is characterized in that the hardenable oligomer comprises at least one hexa-functional aromatic urethane acrylate.

According to another particular embodiment, the varnish to coat the surface of a printed substrate and deposited by inkjet is characterized in that the hardenable oligomer comprises at least one Bisphenol-A epoxy diacrylate.

In some embodiments, the varnish to coat the surface of a printed substrate and deposited by inkjet is characterized in that the varnish composition comprises at least one additive having a particle size less than 50 μm, this additive being:
a matting agent to obtain a matt or satin varnish, and/or
glitter to obtain a glitter varnish, and/or
pigments and/or dyes to obtain a coloured varnish, and/or
fluorescent pigments and/or dyes to obtain a fluorescent varnish, and/or
pigments and/or dyes sensitive to black light to obtain a varnish with optical effect.

In some embodiments, the varnish to coat the surface of a substrate (e.g. a printed substrate) and deposited by inkjet is characterized in that the varnish composition has a particle size adapted to pass through a nozzle when deposited by inkjet onto the printed substrate.

According to one preferred but non-limiting operating mode of the invention, the physical parameters of the components or of the composition of the application are determined at the indicated temperatures and under usual pressure conditions on the earth's surface, preferably in the order of one atmosphere (1013 mBar). Viscosity can thus be measured using a HAAKE Viscotester 550 equipped with NV Cup and NV Rotor which are known measuring instruments marketed by ThermoFisher and use a temperature regulation system connected to a thermostat-controlled bath to hold the varnish sample at a temperature of 25[deg]C. Similarly, the surface tension is measured using a DSA 100 tensiometer using the Pendant Drop method marketed by KRÜSS. Particle size and conductivity are respectively measured using particle size measurement apparatus called MASTERSIZER 2000 marketed by MALVERN, and a CYBERSCAN CON 11 conductivity meter made by EUTECH INSTRUMENTS equipped with a measuring cell referenced ECCONSEN91W/35608-50 and having a cell constant of K=1.0.

It will be obvious for persons skilled in the art that the present invention allows embodiments under numerous other specific forms without departing from the field of application of the invention as claimed. Therefore the described embodiments are to be construed as illustrations which can be modified within the field defined by the scope of the appended claims.

1. A varnish to coat the surface of a substrate and deposited by inkjet, the composition of the varnish at least comprising:
a hardenable oligomer,
a hardenable monomer, at least one hardenable monomer contained in the composition being selected from a group formed by alkoxylated and/or poly-alkoxylated acrylic monomers having one or more di- or tri-acrylates, and
a photoinitiator,
wherein at least one photoinitiator is a bis-(2,4,6-trimethylbenzoyl)-phenylphosphine oxide, and in that at least one hardenable oligomer has a viscosity higher than 0.1 Pa·s at 23° C. and lower than 1 Pa·s at 23° C., and in that the weight ratio between hardenable oligomer and hardenable monomer is between 1:25 and 1:6, and in that the varnish has a viscosity of between 5 mPa·s and 40 mPa·s at 25° C.

2. The varnish according to claim 1 wherein its viscosity is lower than 22 mPa·s at 25° C.

3. The varnish according to claim 1 wherein at least one hardenable oligomer is selected from among oligomers having viscosity higher than 0.1 Pa·s at 23° C. and lower than 1 Pa·s at 23° C., and in that the said selected hardenable oligomers represent at least 75 weight % of the hardenable oligomers in the varnish composition.

4. The varnish according to claim 1 wherein the hardenable oligomer is a modified urethane triacrylate.

5. The varnish according to claim 1 wherein the hardenable oligomers represent 7 to 25 weight % of the varnish.

6. The varnish according to claim 1 wherein the alkoxylated and/or poly-alkoxylated acrylic monomers having one or more di- or tri-acrylates represent 8 to 30 weight % of the varnish.

7. The varnish according to claim 1 wherein the di-acrylate and tri-acrylate monomers are selected from among hexanediol di-acrylate (HDDA), dipropyleneglycol diacrylate, tripropylene glycol diacrylate, polyethylene glycol diacrylate, propoxylated neopentylglycol diacrylate, esterdiol diacrylate (EDDA), triethylene glycol diacrylate (TIEGDA), trimethylol propane tri-acrylate, propoxylated glycerol tri-acrylate, propoxylated (3) trimethylolpropane triacrylate (TMP3POTA), ethoxylated (6) trimethylolpropane triacrylate (TMP6EOTA), or a mixture of two or more of these monomers.

8. The varnish according to claim 1 wherein the hardenable monomers completing the varnish composition comprise at least one function monomer ensuring adhesion to the substrate.

9. The varnish according to the preceding claim wherein the adhesion function monomer represents 10 to 25 weight % of the varnish.

10. The varnish according to claim 1 wherein the hardenable monomers completing the varnish composition comprise at least one function monomer allowing a reduction in the viscosity of the varnish.

11. The varnish according to claim 10 wherein the viscosity function monomer is selected from among aliphatic alkyl acrylates having more than five carbon atoms or a mixture of two or more of these monomers.

12. The varnish according to claim 11 wherein the viscosity function monomer represents 5 to 25 weight % of the varnish.

13. The varnish according to claim 1 wherein the photoinitiator is selected from among bis-(2,4,6-trimethylbenzoyl)-phenylphosphine oxide (e.g. Irgacure 819), alpha-hydroxy-cyclohexyl-phenyl-ketone (e.g. Esacure KS 300) and difunctional α-hydroxy ketone (e.g. Esacure One.

14. The varnish according to claim 1 wherein the photoinitiators represent less than 20 weight % of the varnish.

15. The varnish according to claim 1 wherein the varnish composition also comprises:
at least one surfactant, and/or
at least one antioxidant, and/or
at least one anti-foam agent.

16. The varnish according to claim 15 wherein the varnish comprises at least the six following components;
hardenable oligomer,
hardenable monomer,
photoinitiator,
surfactant,
antioxidant, and
anti-foam agent.

17. The varnish according to claim 1 wherein the varnish composition also comprises one or more colouring agents.

18. The varnish according to claim 1 wherein its conductivity is lower than 1.5 μS.

19. A process for producing the varnish according to claim 1, successively comprising:
a step to mix a viscosity-reducing hardenable monomer with a free radical inhibitor and a photoinitiator at a temperature of between 150 and 300° C.;
a step to cool the mixture; and
a step to add to the cooled mixture and under agitation at least one hardenable oligomer depending on the composition of the varnish, and at least one additional hardenable monomer depending on the composition of the varnish, and any other element included in the composition of the varnish.

20. A process for producing a varnish according to claim 19 wherein the process comprises a step to filter the mixture obtained to a particle size adapted for passing through a nozzle when deposited by inkjet on the substrate.

21. A method of use of the varnish according to claim 1 as varnish and/or ink for inkjet printing technology comprising a step to dry and/or polymerise the said varnish and/or said ink, wherein the temperature to which the varnish and/or ink is subjected when passing through the print-heads is between 25 and 35° C., and in that the drying and/or polymerising of the said varnish is conducted at substrate travel speeds ranging from 0.05 to 10 m/s.

22. A method of use of the varnish according to claim 1 for inkjet printing technology wherein the technology comprises a drying and/or polymerisation step of the said varnish, and in that this step comprises exposure of the varnish to ultraviolet radiation.
